(19) United States
(12) Patent Application Publication
(10) Pub. No.: US 2022/0379374 A1
(43) Pub. Date: Dec. 1, 2022

(54) METHOD FOR MARKING A COMPONENT

(71) Applicant: Miba Sinter Austria GmbH, Laakirchen (AT)

(72) Inventors: Mario MITTERMAIR, Puchkirchen (AT); Harald KAISER, Kirchham (AT); Christian POINTNER, Bad Wimsbach/Neydharting (AT)

(73) Assignee: Miba Sinter Austria GmbH, Laakirchen (AT)

(21) Appl. No.: 17/739,290

(22) Filed: May 9, 2022

(30) Foreign Application Priority Data
Jun. 1, 2021 (AT) GM 50113/2021

(51) Int. Cl. B22F 3/105

(52) U.S. Cl. CPC B22F 3/105; B22F 2998/10

(57) ABSTRACT

A method for marking a component by applying a marking into a surface of the component includes the following steps: providing a powder; producing a green compact from the powder by filling the powder into a mold and pressing the filled-in powder; applying a multi-dimensional code into/onto the surface of the green compact as a marking; sintering the green compact; optionally hardening the sintered green compact; wherein the multi-dimensional code is generated on a pressing surface of the green compact in one single step.

### CROSS REFERENCE TO RELATED APPLICATIONS

Applicant claims priority under 35 U.S.C. § 119 of Austrian Application No. GM 50113/2021 filed Jun. 1, 2021, the disclosure of which is incorporated by reference.

### BACKGROUND OF THE INVENTION

### 1. Field of the Invention

The invention relates to a method for marking a component by applying a marking into a surface of the component, comprising the following steps: providing a powder; producing a green compact from the powder by filling the powder into a mold and pressing the filled-in powder; applying a multi-dimensional code into the surface of the green compact as a marking; sintering the green compact; optionally hardening the sintered green compact.

The invention further relates to a component produced from a sintering material according to a powder-metallurgical method, wherein a multi-dimensional code is arranged in a surface of the component.

### 2. Description of the Related Art

It is already known from the prior art that sintered products are marked and/or coded by applying a code on the green compact. JPH-05185714 A, for example, described a marking method for a powder-sintered product, comprising: injection molding a mixture of metallic and ceramic powder and an organic binding agent; applying a laser marking of letters on the green compact; debinding the green compact; and sintering the green compact.

In this regard, it is considered problematic that cavities which are essentially as large as one dot of the code cause reading errors or a code reader.

To avoid this problem, DE 11 2018 003 673 T5 suggests a laser marking method for a powder compact containing metal powder, comprising a first step of scanning with laser light of first power which is weaker over a predetermined area in a surface of the powder compact, to melt and smooth inside of the predetermined area, and a second step of scanning with laser light of second power which is greater, to form a dot formed of a recess of a predetermined depth at a predetermined location in the predetermined area. This document also describes a sintered product which is obtained by sintering a powder compact containing metal powder, comprising a two-dimensional code with a plurality of dots, which are applied onto a surface of the powder compact by laser marking, wherein the oxygen content on a surface of the sintered product in the proximity of the dots amounts to 2 wt. % or less.

### SUMMARY OF THE INVENTION

It was the object of the present invention to provide a simple possibility for the traceability of a powder-metallurgically produced component.

This object is achieved by the initially mentioned method in which it is provided that the multi-dimensional code is generated on a pressing surface of the green compact in a single step.

Furthermore, the object of the invention is achieved by the initially mentioned component, in which the multi-dimensional code has a cell contrast of at least 70%.

The advantage of this is that, as opposed to the method according to DE 11 2018 003 673 T5 mentioned above, no leveling of the surface to be marked must be carried out. With leveling, pores are closed, which means that the marking itself takes longer because more material has to be melted with the laser. Surprisingly, the shortcoming in the laser marking of green compacts described in DE 11 2018 003 673 T5 does not result in illegibility of the code, although such codes are usually generated with narrowly spaced dots. The method according to the invention results in a component, the markings of which have the aforementioned luminance. Hence, the marking better blends in with the overall appearance of the component, without coming to the fore in too strong a contrast.

Preferably, according to an embodiment variant of the invention, the multi-dimensional code is generated by means of an electromagnetic radiation, in particular a bundled light radiation. Compared to other marking methods, hence, the penetration depth of the marking can be determined relatively easily, to thus allow for the luminance of the code to be adjusted accordingly. If the marking is formed to extend into a relatively large depth, it appears brighter on the sintered component. Moreover, hence, as compared to other methods of code generation, the code can be inserted into the material in a relatively gentle manner.

Preferably, according to a further embodiment variant of the invention, a data matrix code is produced in the surface of the component to mark the component. Thus, it is possible to place a relatively high amount of information on a relatively small surface, wherein this code is embodied in a simple way as compared to other two-dimensional codes, whereby a contrast reduction does not and/or not in a disturbing manner affect the reading accuracy of the coding. This, in turn, supports marking of a green compact in just one step without previous preparation of the surface to be marked.

According to a further embodiment variant, it can be provided for quick marking of the component in serial production that the multi-dimensional code is generated on a surface of a maximum of 400 mm².

For further improving the aforementioned effects, according to another embodiment variant of the invention, it can be provided that the multi-dimensional code is formed in a depth of between 25 μm and 50 μm, measured from the surface of the component, at least in some sections. At a depth of more than 50 μm, the sharpness of the inserted dot would be impacted too strongly, since more material around the dot per se is heated and thus possibly sintered or even melted during marking.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a sintered component with a marking;

FIG. 2 shows a microstructure depiction of the marked surface of the component;

FIG. 3 shows the process of marking the component.

### DETAILED DESCRIPTION OF PREFERRED EMBODIMENTS

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

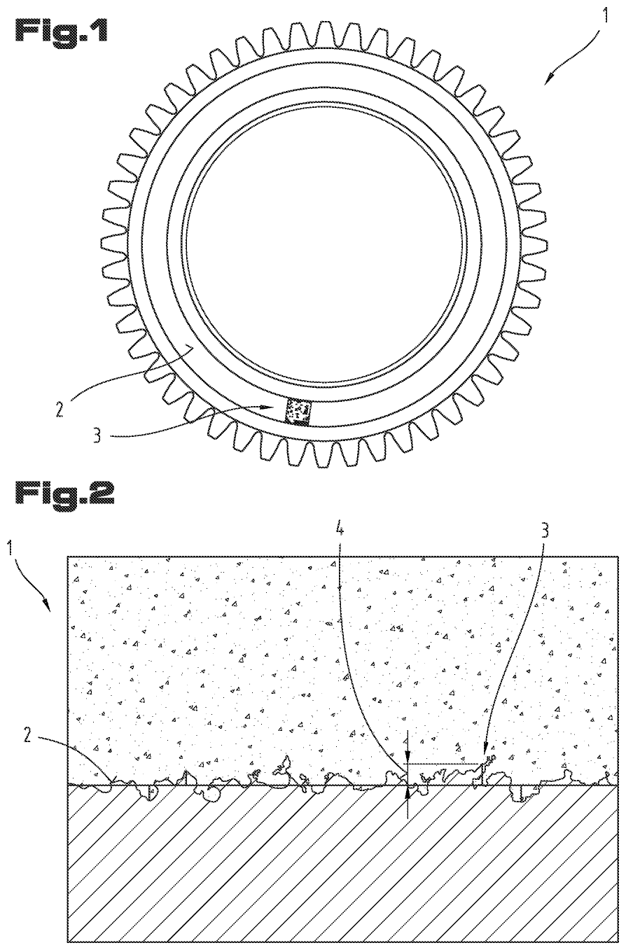

FIG. 1 shows a component 1. The component 1 is a gear. However, it should be noted that the shown form of a component 1 is to be understood merely as a representation for further components 1 if these are components 1 produced according to a powder-metallurgical method. Thus, the invention is not limited to gears.

The component 1 has a marking 3 on a surface 2, for example a front side. The marking 3 is a multi-dimensional code, i.e. no marking 3 with alphanumerical signs (letters, numbers etc.). The marking 3 in particular consists of lines and/or dots (ideally rectangles and squares).

The multi-dimensional code preferably is a two-dimensional code, such as a matrix code, e.g. a QR code. In particular, the code according to an embodiment variant of the invention is a so-called data matrix code. Since these codes are known per se, further explanations in this regard can be dispensed with. The person skilled in the art is referred to the relevant literature in this regard. The data matrix code, for example, is defined in the ISO standard IEC 16022:2006.

The marking 3 can also be formed by a three-dimensional code, such as in particular a three-dimensional QR code, by material changes of the component 1 being caused when the code is generated spaced from the surface 2 within the component 1 according to the desired coding.

As already mentioned, the component 1 is produced according to a powder-metallurgical method. For this purpose, a corresponding (metal) sintering powder is provided, such as a common sintering steel powder. Then, a so-called green compact is produced from this powder.

A green compact is understood to be a molded part pressed from a sintering powder at the stage immediately after pressing of the sintering powder and before sintering, as corresponds to general technical language use. Thus, the green compact is a blank from the (finished) component 1 is created by sintering.

The production of the green compact can be carried out for example in a die with a mold cavity. The mold cavity together with the pressing stamp(s) generally comprises the negative form of the subsequent component 1. “Generally” means that details of component 1 which cannot be produced by pressing, such as some undercuts, etc., can be produced later.

After pressing the powder to the green compact, it is ejected from the die and fed to the single-stage or multi-stage sintering process. The sintering process—depending on the powder used—may for example be carried out at a temperature of between 600° C. and 1300° C.

After sintering, the sintered green compact can be post-processed, for example calibrated and/or hardened.

For better traceability and/or assignability of a specific component 1, the marking 3 is provided in the form of a multi-dimensional code now. This code can include information on the production date, the production time, the production place, the lot, etc. By means of this data, the component 1 can be unambiguously assigned also after longer use. For this purpose, the code can be read with a suitable reader, such as a scanner or a camera etc., and the corresponding readable alphanumeric signs can be generated from this data. Readers are known from the prior art.

The code is introduced into the green compact. For this purpose, the marking can be provided before or after ejection of the green compact from the die and/or the forming tool. Thus, the code is introduced into the, in particular untreated, pressing surface, i.e. the surface that the green compact has immediately after pressing. No leveling of the surface 2, onto/into which the marking 3 is applied and/or introduced, takes place. The green compact has a green compact density on the surface of between 6.6 g/cm³ and 7.3 g/cm³.

Thus, the code is generated on and/or in the untreated green compact surface in one single processing step.

The multi-dimensional code can, in principal, be generated using any suitable tool. However, preferably an electromagnetic radiation, particularly preferred a laser, is used on and/or in the surface 2 of the component 1 to generate the code.

For the aforementioned reasons, it is advantageous according to a further embodiment variant if the two-dimensional code is formed with a (maximum) depth 4 of between 25 μm and 50 μm, measured from the surface 2 of the component 1, at least in some sections. This can be seen in FIG. 2 which shows a microstructure depiction of the component 1 according to FIG. 1 in the region of the marking 3. In this regard “with a depth 4” means that the component 1 has a marking 3 which has code components which reach from the surface into the said depth 4. In the case of electromagnetic radiation, in particular laser light, for producing the code, reference can also be made to burn-in depth.

Thus, not the entire marking 3 and/or the entire code has to be formed to reach into said depth 4. However, an average depth 4 can be selected from a range of between 20 μm and 40 μm, for example from a range of between 25 μm and 30 μm. The average depth 4 is calculated as the arithmetical mean value from the maximum depths 4 of ten code components (bars and/or dots).

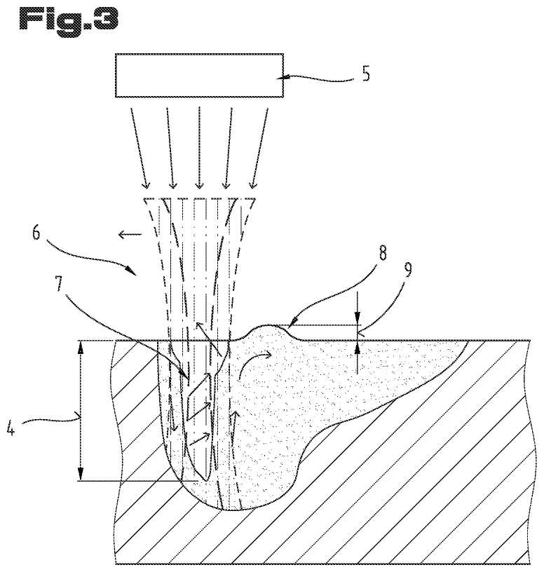

FIG. 3 shows the generation of the marking in a simplified manner. Laser light 6 is irradiated into the green compact from a laser 5, causing the pressed powder in this area to melt and partially vaporize. This metal vapor leaves a recess 7 (hole), which forms a component of the code to be introduced, in the green compact. As can be seen from FIG. 3, the recess 7 is surrounded by a melt bath which solidifies again after marking. Thus, the depth 4 is smaller than the depth up to which the pressed powder is melted. Moreover, the recess 7 has an edge with a material accumulation 8 which adds to the appearance of the code, i.e. of the marking 3, on the component 1.

The material accumulation can be generated with a height 9 which amounts to between 20 μm and 40 μm.

By the method according to the invention, a component 1 (which can also be referred to as sintered component) produced in a powder-metallurgical method can be generated which comprises a marking 3 of a code, wherein the code, i.e. the components of the code (bars and/or dots) have a cell contrast of at least 70% (ISO/IEC TR 29158-2011-10), in particular a cell contrast between 70% and 95% (ISO/IEC TR 29158-2011-10). In this regard, the cell contrast is the difference between the mean value of the bright and dark regions divided by the mean value of the light area.

The Michelson contrast Km is calculated as Km=(Lmax−Lmin)/(Lmax+Lmin).

The exemplary embodiments show or describe possible embodiment variants the component 1 and/or the marking 3, while it should be noted at this point that combinations of the individual embodiment variants are also possible.

Finally, as a matter of form, it should be noted that for ease of understanding of the structure of component 1 and/or the marking 3, these are not obligatorily depicted to scale.

Although only a few embodiments of the present invention have been shown and described, it is to be understood that many changes and modifications may be made thereunto without departing from the spirit and scope of the invention.

### LIST OF REFERENCE NUMBERS

1 Component
2 Surface
3 Marking
4 Depth
5 Laser
6 Laser light
7 Recess
8 Material accumulation

What is claimed is:

1. A method for marking a component (1) by applying a marking (3) into a surface (2) of the component (1), comprising the following steps:
providing a powder;
producing a green compact from the powder by filling the powder into a mold and pressing the filled-in powder;
applying a multi-dimensional code into/onto the surface (2) of the green compact as a marking (3);
sintering the green compact; and
optionally hardening the sintered green compact;
wherein the multi-dimensional code is generated on a pressing surface of the green compact in one single step.

2. The method according to claim 1, wherein the multi-dimensional code is generated by means of an electromagnetic radiation.

3. The method according to claim 1, wherein a data matrix code is produced in/on the surface (2) of the component (1) to mark the component (1).

4. The method according to claim 1, wherein the multi-dimensional code is generated on a surface of a maximum of 100 mm².

5. The method according to claim 1, wherein the two-dimensional code is formed with a depth (4) of between 25 μm and 50 μm, measured from the surface (2) of the component (1), at least in some sections.

6. A component (1) produced from a sintering material in a powder-metallurgical method, wherein a multi-dimensional code is arranged in a surface (2) of the component (1), and wherein the two-dimensional code has a cell contrast of at least 70%.
